(19) United States
(12) Patent Application Publication
(10) Pub. No.: US 2018/0018337 A1
(43) Pub. Date: Jan. 18, 2018

(54) SYSTEM AND METHOD FOR PROVIDING CONTENT BASED ON CONTEXTUAL INSIGHTS

(71) Applicant: Cortica, Ltd., TEL AVIV (IL)

(72) Inventors: Igal Raichelgauz, Tel Aviv (IL); Karina Odinaev, Tel Aviv (IL); Yehoshua Y. Zeevi, Haifa (IL)

(73) Assignee: Cortica, Ltd., TEL AVIV (IL)

(21) Appl. No.: 15/667,188

(22) Filed: Aug. 2, 2017

Related U.S. Application Data
(63) Continuation-in-part of application No. 14/280,928, filed on May 19, 2014.
Application No. 14/280,928 is a continuation-in-part of application No. 13/856,201, filed on Apr. 3, 2013.
Application No. 14/280,928 is a continuation-in-part of application No. 13/624,397, filed on Sep. 21, 2012, now Pat. No. 9,191,626.
Application No. 13/624,397 is a continuation-in-part of application No. 13/344,400, filed on Jan. 5, 2012, now Pat. No. 8,959,037.
Application No. 13/344,400 is a continuation of application No. 12/434,221, filed on May 1, 2009, now Pat. No. 8,112,376.
Application No. 12/434,221 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 13/624,397 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 13/624,397 is a continuation-in-part of application No. 12/084,150, filed on Apr. 7, 2009, now Pat. No. 8,655,801.
(60) Provisional application No. 62/370,726, filed on Aug. 4, 2016.
(60) Provisional application No. 61/833,028, filed on Jun. 10, 2013.
(60) Provisional application No. 61/766,016, filed on Feb. 18, 2013.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30; H04N 21/466; H04N 21/2668; H04N 21/258; H04N 7/173; H04L 29/08; H04H 60/66; H04H 60/56; H04H 60/46; H04H 60/37; H04H 20/26; H04N 21/81; H04H 20/10

(52) U.S. Cl. CPC G06F 17/30056; H04N 21/8106; H04N 21/466; H04N 21/2668; H04N 21/25891; H04N 7/17318; H04H 20/103; H04H 60/66; H04H 60/56; H04H 60/46; H04H 60/37; H04H 20/26; H04L 67/10

(57) ABSTRACT

A system, method, and computer-readable medium for providing a content item based on a user interest and an expected action to be performed by a user device. The method includes: querying, based on at least one signature generated for a multimedia content element, a user profile to identify the user interest, wherein a concept of the identified user interest matches a concept represented by the generated at least one signature; generating at least one contextual insight based on the user interest, wherein each contextual insight indicates a user preference; determining the expected action based on the at least one contextual insight; determining, based on the expected action, the content item to be provided to the user device; and providing the determined content item to the user device.

### CROSS-REFERENCE TO RELATED APPLICATIONS

This application claims the benefit of U.S. Provisional Application No. 62/370,726 filed on Aug. 4, 2016. This application is also a continuation-in-part of U.S. patent application Ser. No. 14/280,928 filed on May 19, 2014, now pending, which claims the benefit of U.S. Provisional Application No. 61/833,028 filed on Jun. 10, 2013. The Ser. No. 14/280,928 Application is also a continuation-in-part of U.S. patent application Ser. No. 13/856,201 filed on Apr. 3, 2013, now pending, which claims the benefit of U.S. Provisional Application No. 61/766,016 filed on Feb. 18, 2013. The Ser. No. 14/280,928 Application is also a continuation-in-part of U.S. patent application Ser. No. 13/624,397 filed on Sep. 21, 2012, now U.S. Pat. No. 9,191,626. The Ser. No. 13/624,397 Application is a continuation-in-part of:
(a) U.S. patent application Ser. No. 13/344,400 filed on Jan. 5, 2012, now U.S. Pat. No. 8,959,037, which is a continuation of U.S. patent application Ser. No. 12/434,221 filed on May 1, 2009, now U.S. Pat. No. 8,112,376. The Ser. No. 12/434,221 Application is a continuation-in-part of the below-referenced U.S. patent application Ser. Nos. 12/084,150 and 12/195,863;
(b) U.S. patent application Ser. No. 12/195,863 filed on Aug. 21, 2008, now U.S. Pat. No. 8,326,775, which claims priority under 35 U.S.C 119 from Israeli Application No. 185414, filed on Aug. 21, 2007, and which is also a continuation-in-part of the below-referenced U.S. patent application Ser. No. 12/084,150; and
(c) U.S. patent application Ser. No. 12/084,150 having a filing date of Apr. 7, 2009, now U.S. Pat. No. 8,655,801, which is the National Stage of International Application No. PCT/IL2006/001235 filed on Oct. 26, 2006, which claims foreign priority from Israeli Application No. 171577 filed on Oct. 26, 2005 and Israeli Application No. 173409 filed on Jan. 29, 2006.
All of the applications referenced above are herein incorporated by reference for all that they contain.

### TECHNICAL FIELD

The present disclosure relates generally to the analysis of multimedia content, and more specifically to a system for providing content based on the analysis.

### BACKGROUND

With the abundance of data made available through various means in general and the Internet and world-wide web (WWW) in particular, a need to understand the likes and dislikes of users has become essential for on-line businesses.

Existing solutions provide several tools to identify users' preferences. Some of these existing solutions actively require an input from the users to specify their interests. However, profiles generated for users based on their inputs may be inaccurate, as the users tend to provide only their current interests, or otherwise only provide partial information due to privacy concerns.

Other existing solutions passively track the users' activity through particular web sites such as social networks. The disadvantage with such solutions is that typically limited information regarding the users is revealed, as users tend to provide only partial information due to privacy concerns. For example, users creating an account on Facebook® often provide only the minimum information required for the creation of the account. Additional information about such users may be collected over time, but may take significant amounts of time (i.e., gathered via multiple social media or blog posts over a time period of weeks or months) to be useful for accurate identification of user preferences.

It would therefore be advantageous to provide a solution that overcomes the deficiencies of the prior art. It would be further advantageous if such solution further enables providing relevant content based on the analysis of multimedia content.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for providing a content item based on a user interest and an expected action to be performed by a user device. The method comprises: querying, based on at least one signature generated for a multimedia content element, a user profile to identify the user interest, wherein a concept of the identified user interest matches a concept represented by the generated at least one signature; generating at least one contextual insight based on the user interest, wherein each contextual insight indicates a user preference; determining the expected action based on the at least one contextual insight; determining, based on the expected action, the content item to be provided to the user device; and providing the determined content item to the user device.

Certain embodiments disclosed herein include a non-transitory having stored thereon instructions for causing a processing system to perform a process for providing a content item based on a user interest and an expected action to be performed by a user device, the process comprising: querying, based on at least one signature generated for a multimedia content element, a user profile to identify the user interest, wherein a concept of the identified user interest matches a concept represented by the generated at least one signature; generating at least one contextual insight based on the user interest, wherein each contextual insight indicates a user preference; determining the expected action based on the at least one contextual insight; determining, based on the expected action, the content item to be provided to the user device; and providing the determined content item to the user device.

Certain embodiments disclosed herein include a system for providing a content item based on a user interest and an expected action to be performed by a user device, comprising: a processing circuitry; and a memory, wherein the memory contains instructions that, when executed by the processing circuitry, configure the system to: query, based on at least one signature generated for a multimedia content element, a user profile to identify the user interest, wherein a concept of the identified user interest matches a concept represented by the generated at least one signature; generate at least one contextual insight based on the user interest, wherein each contextual insight indicates a user preference; determine the expected action based on the at least one contextual insight; determine, based on the expected action, the content item to be provided to the user device; and provide the determined content item to the user device.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a block diagram of an interest analyzer according to an embodiment.

FIG. 3 is flowchart illustrating a method for profiling user interests according to an embodiment.

FIG. 4 is a flowchart illustrating a method for generating contextual insights based on analysis of a user's interests and a multimedia content element according to another embodiment.

FIG. 5 is a block diagram depicting the basic flow of information in the signature generator system.

FIG. 6 is a diagram showing the flow of patches generation, response vector generation, and signature generation in a large-scale speech-to-text system.

FIG. 7 is a flowchart illustrating a method for providing recommendations for multimedia content elements to a user based on contextual insights according to an embodiment.

FIG. 8 is a flowchart illustrating a method for providing content items to a user based on expected actions according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Certain embodiments disclosed herein include a system and method for providing recommendations to users based on contextual insights. Contextual insights are generated based on a user profile of a user and a multimedia content element. The contextual insights are conclusions related to a current preference of the user. Generating the contextual insights further includes extracting a user profile from a database of user profiles and analyzing the multimedia content element. The database is created based on collection and storage of user interests. The analysis of the captured multimedia content element includes generating signatures to the multimedia content element. Based on the signatures, one or more concepts of the multimedia content element is determined. Based on an analysis of the concepts and the user interests of the user profile, one or more contextual insights is generated.

Based on the generated contextual insights, recommendations of multimedia content elements are provided to the user. The recommendations may include, but are not limited to, recommendations for multimedia content, recommendations for web sites or pages (via, e.g., a hyperlink to a web page), recommendations for topics of interest (to be, e.g., to be utilized as a query or to customize a user profile), combinations thereof, and the like.

As a non-limiting example, if a user captured an image determined as a self-portrait photograph (typically referred to as a “selfie”) and the user interest is determined as fashion, links through which the user can purchase clothing items that fit the user's size or preferences are provided to the user, for example by sending the recommended links to the user's device.

A user interest may be determined, in part, based on the period of time the user viewed or interacted with the multimedia content elements; a gesture received by the user device such as a mouse click, a mouse scroll, a tap, and any other gesture on a device having, e.g., a touch screen display or a pointing device; content viewed by the user device; and the like. User interests may further be generated at least partially based on personal parameters associated with the user, for example, demographic information related to the user. The personal parameters may be identified in, e.g., a user profile associated with the user.

According to another embodiment, a user interest may be determined based on a match between multimedia content elements viewed by a user and their respective impressions. According to yet another embodiment, a user interest may be generated based on multimedia content elements that the user uploads or shares on the web, such as social networking websites. It should be noted that the user interest may be determined based on one or more of the above identified techniques.

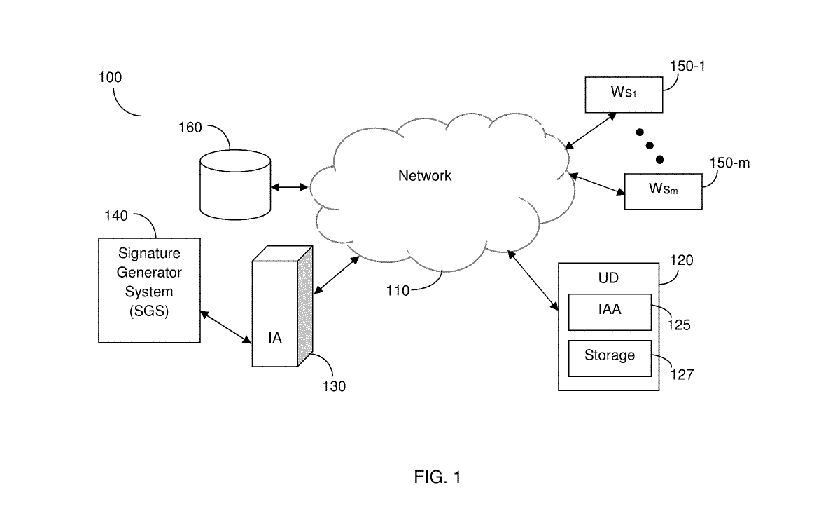

FIG. 1 shows is an example network diagram 100 utilized to describe the various disclosed embodiments. As illustrated in FIG. 1, a network 110 enables the communication between a user device (UD) 120, an interest analyzer (IA) 130, a plurality of web sources 150-1 through 150-m (hereinafter referred to individually as a web source 150 and collectively as web sources 150), and a database 160. The network 110 may be the Internet, the world-wide-web (WWW), a local area network (LAN), a wide area network (WAN), a metro area network (MAN), and other networks capable of enabling communication between the elements of the network diagram 100.

The user device 120 may be, for example, a personal computer (PC), a personal digital assistant (PDA), a mobile phone, a tablet computer, a smart phone, a wearable computing device, and the like.

In some implementations, the user device 120 may have installed therein an interest analyzer agent (IAA) 125. The interest analyzer agent 125 may be a dedicated application, script, or any program code stored in a memory of the user device 120 and is executable, for example, by a processing circuitry (e.g., a microprocessor) of the user device 120. The interest analyzer agent 125 may be configured to perform some or all of the processes performed by an interest analyzer 130 that are disclosed herein.

The user device 120 may include a local storage 127. The local storage 127 may include multimedia content elements captured or received by the user device 120. For example, the local storage 127 may include photographs and videos either captured via a camera (not shown) of the user device 120 or downloaded from a website (e.g., via the network 110).

The user device 120 is configured to send multimedia content elements to the interest analyzer 130 via the network 110. The content displayed on the user device 120 may be downloaded from one of the web sources 150, may be embedded in a web-page displayed on the user device 120, or a combination thereof. The uploaded multimedia content element can be locally saved in the user device 120 or can be captured by the user device 120. For example, the multimedia content element may be an image captured by a camera installed in the user device 120, a video clip downloaded to and saved in the user device 120, and so on. A multimedia content element may be, for example, an image, a graphic, a video stream, a video clip, an audio stream, an audio clip, a video frame, a photograph, an image of signals (e.g., spectrograms, phasograms, scalograms, etc.), portions thereof, or combinations thereof.

Each of the web sources 150 may be, for example, a web server, an application server, a data repository, a database, a website, an e-commerce website, a content website, and the like. The web sources 150 include or store multimedia content elements utilized for generating contextual insights. Alternatively or collectively, the multimedia content elements utilized for generating contextual insights may be stored in the local storage 127 of the user device 120, a storage of the interest analyzer 130, or both.

The various embodiments disclosed herein may be realized using the interest analyzer 130 and a signature generator system (SGS) 140. The interest analyzer 130 is configured to create user profiles for user devices including a profile for the user of the user device 120 as will be discussed below.

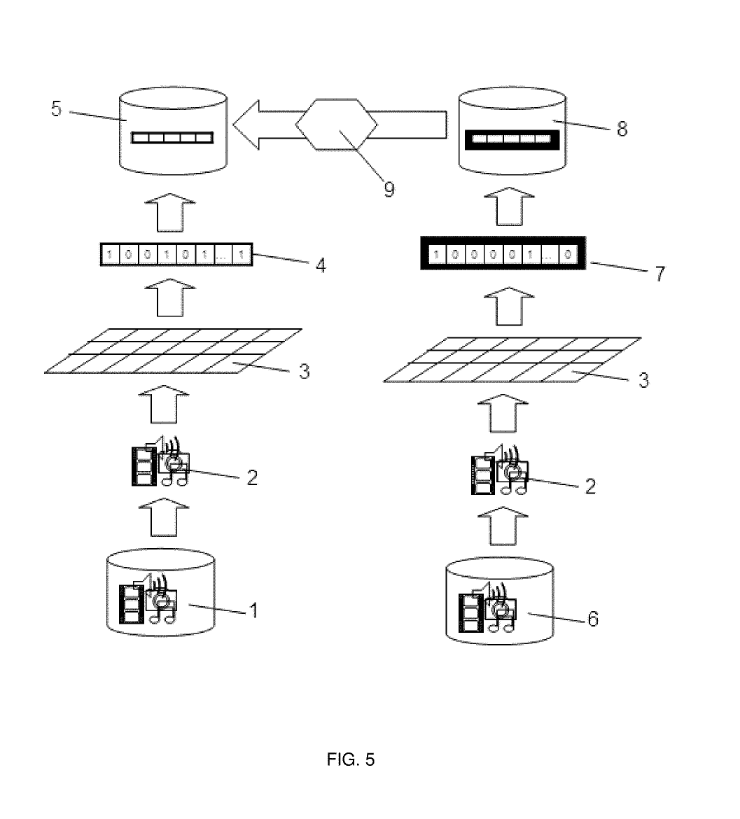

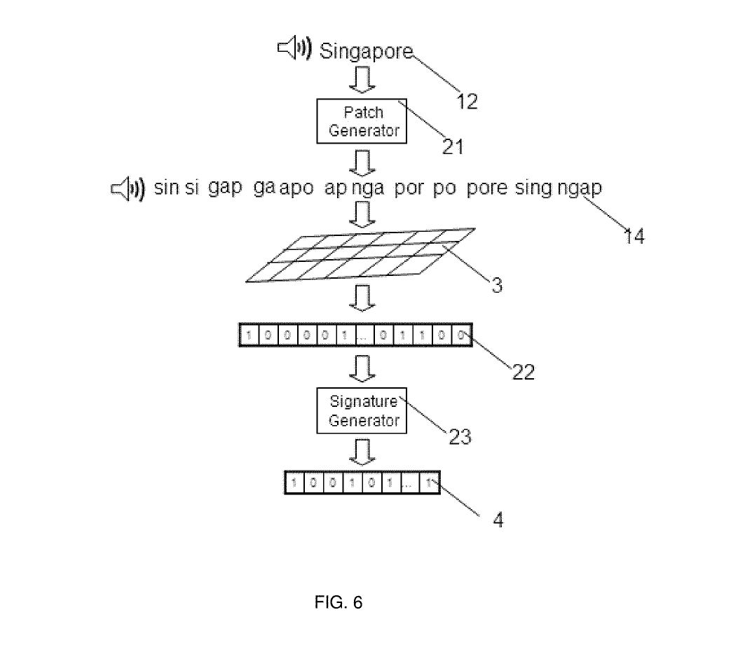

The SGS 140 is configured to generate signatures for multimedia content elements as explained in more detail herein below with respect to FIGS. 5 and 6. Each of the interest analyzer 130 and the SGS 140 typically includes a processing system, such as a processing circuitry (not shown) that is communicatively connected to a memory. The memory contains instructions that can be executed by the processing circuitry. The interest analyzer 130 also includes an interface (not shown) to the network 110. In some implementations, the SGS 140 may be integrated in the interest analyzer 130. The interest analyzer 130, the SGS 140, or both may also include a plurality of computational cores having properties that are at least partly statistically independent from other cores of the plurality of computational cores. The computational cores may be utilized to generate signatures as further discussed herein below.

Each signature represents a concept, where a concept is a collection of signatures and metadata representing the concept. Utilizing the signatures to determine contextual insights allows for more accurate contextual insights than, for example, based on metadata of multimedia content elements alone. Further, the signatures generated as described herein may result in more accurate analysis of multimedia content features than, for example, existing image analysis solutions. In particular, the signatures may be robust to noise and distortion.

In an example implementation, a tracking agent (not shown) or other means for collecting information through the user device 120 may be configured to provide the interest analyzer 130 with tracking information related to a multimedia content element viewed or uploaded by the user and related to the interaction of the user with the multimedia content element. The information may include, but is not limited to, the multimedia content element (or a URL referencing the multimedia content element), the amount of time the user viewed the multimedia content element, a user gesture made with respect to the multimedia content element, a URL of a webpage in which the element was viewed or uploaded to, a combination thereof, and so on. The tracking information is provided for each multimedia content element viewed on or uploaded via the user device 120.

The interest analyzer 130 is configured to determine a user impression with respect to the received tracking information. The user impression may be determined for each multimedia content element or for a group of multimedia content elements. As noted above, the user impression indicates the user's attention with respect to a multimedia content element or group of multimedia content elements. A user impression may be determined based on, but not limited to, a click on an element, a scroll, hovering over an element with a mouse, a change in volume, one or more key strokes, and so on. The user impression may further be determined to be either positive (i.e., demonstrating that a user is interested in the impressed element) or negative (i.e., demonstrating that a user is not particularly interested in the impressed element). A filtering operation may be performed on the tracking information in order to remove details that are not helpful in determining user impressions and to analyze only meaningful impressions. Impressions may be determined as meaningless and thereby ignored, if, for example, a value associated with the impression is below a predefined threshold.

For example, in an embodiment, if the user hovered over the element using his mouse for a very short time (e.g., less than 0.5 seconds), then such a measure is ignored. To this end, in a further embodiment, the interest analyzer 130 is configured to compute a quantitative measure for the impression. To this end, for each input measure that is tracked by the tracking agent, a predefined number may be assigned. For example, a dwell time over the multimedia content element of 2 seconds or less may be assigned with a ‘5’; whereas a dwell time of over 2 seconds may be assigned with the number ‘10’. A click on the element may increase the value of the quantitative measure by assigning another quantitative measure of the impression. After one or more input measures of the impression have been made, the numbers related to the input measures provided in the tracking information are accumulated. The total of these input measures is the quantitative measure of the impression. Thereafter, the interest analyzer 130 is configured to compare the quantitative measure to a predefined threshold, and if the number exceeds the threshold, the impression is determined to positive. In a further embodiment, the input measure values may be weighted.

For example, if a user hovers over the multimedia content element for less than 2 seconds but then clicks on the element, the score may be increased from 5 to 9 (i.e., the click may add 4 to the total number). In that example, if a user hovers over the multimedia content element for more than 2 seconds and then clicks on the element, the score may be increased from 10 to 14. In some embodiments, the increase in score may be performed relative to the initial size of the score such that, e.g., a score of 5 will be increased less (for example, by 2) than a score of 10 would be increased (for example, by 4).

The multimedia content element or elements that are determined as having a positive user impression are sent to the SGS 140. The SGS 140 is then configured to generate signatures for each multimedia content element or for each portion thereof. The generated signature(s) may be robust to noise and distortions as discussed below.

It should be appreciated that the signatures may be used for profiling the user's interests, because signatures typically allow for more accurate reorganization of multimedia content elements in comparison than, for example, utilization of metadata. The signatures generated by the SGS 140 for the multimedia content elements allow for recognition and classification of multimedia content elements such as content-tracking, video filtering, multimedia taxonomy generation, video fingerprinting, speech-to-text, audio classification, element recognition, video/image search and any other application requiring content-based signatures generation and matching for large content volumes such as, web and other large-scale databases. For example, a signature generated by the SGS 140 for a picture showing a car enables accurate recognition of the model of the car from any angle at which the picture was taken.

In an embodiment, the generated signatures are matched against a database of concepts (not shown) to identify a concept that can be associated with the signature and, thus, with the multimedia content element. For example, an image of a tulip would be associated with a concept of flowers. A concept (or a matching concept) is a collection of signatures representing a multimedia content element and metadata describing the concept. The collection of signatures is a signature reduced cluster generated by inter-matching signatures generated for the multimedia content elements. The techniques for generating concepts and a concept-based database are disclosed in U.S. Pat. No. 9,031,999, assigned to the common assignee, which is hereby incorporated by reference.

Based on the identified concepts, the interest analyzer 130 is configured to create or update the user profile. That is, for each user, when a number of similar of identical concepts for multiple multimedia content elements have been identified over time, the user's preference or interest can be established. The interest may be saved to a user profile created for the user. Whether two concepts are sufficiently similar or identical may be determined by, e.g., performing concept matching between the concepts. A matching concept may be represented using at least one signature. Techniques for concept matching are disclosed in U.S. Pat. No. 9,639,532, assigned to common assignee, which is hereby incorporated by reference.

For example, a concept of flowers may be determined as associated with a user interest in ‘flowers’ or ‘gardening.’ In one embodiment, the user interest may simply be the identified concept. In another embodiment, the interest may be determined using an association table which associates one or more identified concepts with a user interest. For example, the concepts of ‘flowers’ and ‘spring’ may be associated with the interest of ‘gardening’. Such an association table may be maintained in the interest analyzer 130 or in the database 160.

In an embodiment, the interest analyzer 130 is further configured to generate a contextual insight based on the user's interest and on the analysis of the multimedia content element. Contextual insights are conclusions determined with respect to a current preference of users. Upon receiving at least one multimedia content element from the user device 120, at least one signature is generated for the received multimedia content element. The interest analyzer 130 is configured to determine a concept based on a concept represented by the at least one generated signature.

The interest analyzer 130 queries the user profile stored in the database 160 to determine at least one user interest based on the determined concept. Based on a response to the query, the interest analyzer 130 is configured to generate a contextual insight for the at least one user interest and the at least one signature.

In an embodiment, the interest analyzer 130 is configured to provide content related to the current user interest. To this end, the interest analyzer 130 is configured to determine one or more expected actions that the user of the user device 120 is interested in performing. Each action may be, for example, a certain request for communication, e.g., voice call request, text message, etc. The request may further be a request for content, e.g., launching a certain web-page, launching a certain application program, etc. According to another embodiment, the action may be a utility initialization, e.g., initializing a flashlight of the user device 120, muting alerts of the user device 120, etc. The interest analyzer 130 is configured to search for one or more content items that can assist in the expected actions. The interest analyzer 130 is configured to assist in the expected actions by providing one or more of the content items found during the search.

As a non-limiting example, in case a contextual insight indicates that the user interest in ordering a taxi to the user's current location, an application program for ordering a taxi, e.g., Uber® is launched on the user device 120. The search may include querying one or more of the plurality of web sources 150 based on the contextual insight indicating interest in a taxi. The Uber® application, found during the search, may be sent to the user device 120 and caused to be executed.

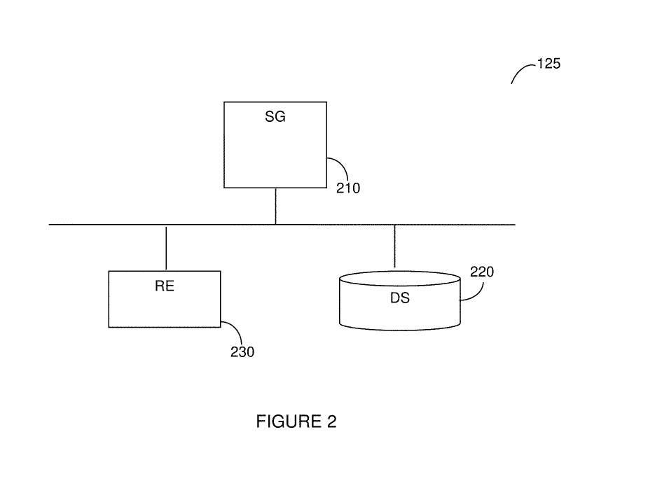

It should be noted that certain tasks performed by the interest analyzer 130 and the SGS 140 may be carried out, alternatively or collectively, by the user device 120 and the interest analyzer agent 125. Specifically, in an embodiment, signatures may be generated by a signature generator (not shown in FIG. 1) of the user device 120. The interest analyzer agent 125 may be configured to generate contextual insights and to search for content items matching the contextual insights. The interest analyzer agent 125 may be further configured to identify matching content items and to cause a display of the matching content items on the user device 120 as recommendations. An example block diagram of an interest analyzer agent 125 installed on a user device 120 is described further herein below with respect to FIG. 2.

It should further be noted that the signatures may be generated for multimedia content elements stored in the web sources 150, in the local storage 127 of the user device 120, or a combination thereof.

FIG. 2 depicts an example block diagram of an interest analyzer agent 125 installed on the user device 120 according to an embodiment. The interest analyzer agent 125 may be configured to access an interface of a user device or a server. The interest analyzer agent 125 is further communicatively connected to a processing circuitry (e.g., a processing circuitry of the user device 120, not shown) such as a processor and to a memory (e.g., a memory of the user device 120, not shown). The memory contains instructions that, when executed by the processing circuitry, configures the interest analyzer agent 125 as further described herein. The interest analyzer agent 125 may further be communicatively connected to a storage unit (e.g., the storage 127 of the user device 120, not shown) including a plurality of multimedia content elements.

In an embodiment, the interest analyzer agent 125 includes a signature generator (SG) 210, a data storage (DS) 220, and a recommendations engine 230. The signature generator 210 may be configured to generate signatures for multimedia content elements. In a further embodiment, the signature generator 210 includes a plurality of computational cores as discussed further herein above, where each computational core is at least partially statistically independent of the other computations cores.

The data storage 220 may store a plurality of multimedia content elements, a plurality of concepts, signatures for the multimedia content elements, signatures for the concepts, or a combination thereof. In a further embodiment, the data storage 220 may include a limited set of concepts relative to a larger set of known concepts. Such a limited set of concepts may be utilized when, for example, the data storage 220 is included in a device having a relatively low storage capacity such as, e.g., a smartphone or other mobile device, or otherwise when lower memory use is desirable.

The recommendations engine 230 may be configured to generate contextual insights based on multimedia content elements related to the user interest, to query sources of information (including, e.g., the data storage 220 or another data source), and to cause execution or display of recommended content items on the user device 120.

In an embodiment, the interest analyzer agent 125 is configured to receive one or more multimedia content element. The interest analyzer agent 125 is configured to initialize the signatures generator 210 to generate signatures for the multimedia content element. The interest analyzer agent 125 is further configured to query a user profile of the user stored in the data storage 220 to determine a user interest and to generate a contextual insight based on the user interest and the signatures. Based on the contextual insight, the recommendations engine 230 is initialized to search for one or more content items that match the contextual insight. The matching content items may be provided by the recommendations engine 230 to the user as recommendations via the interface.

Each of the recommendations engine 230 and the signature generator 210 can be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

In certain implementations, the recommendation engine 230, the signature generator 210, or both can be implemented using an array of computational cores having properties that are at least partly statistically independent from other cores of the plurality of computational cores. The computational cores are further discussed below.

According to another implementation, the processes performed by the recommendation engine 230, the signature generator 210, or both, can be executed by a processing circuitry of the user device 120 or of the interest analyzer 130. Such processing system may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

It should be noted that, although FIG. 2 is described with respect to an interest analyzer agent 125 included in the user device 120, any or all of the components of the interest analyzer agent 125 may be included in another system or systems (e.g., the interest analyzer 130, the signature generator system 140, or both) and utilized to perform some or all of the tasks described herein without departing from the scope of the disclosure. As an example, the interest analyzer agent 125 operable in the user device 120 may send multimedia content elements to the signature generator system 140 and may receive corresponding signatures therefrom. As another example, the user device 120 may send signatures to the interest analyzer 130 and may receive corresponding recommendations or concepts therefrom. As yet another example, the interest analyzer agent 125 may be included in the interest analyzer 130 and may provide recommendations to the user device 120 based on multimedia content elements identified by or received from the user device 120.

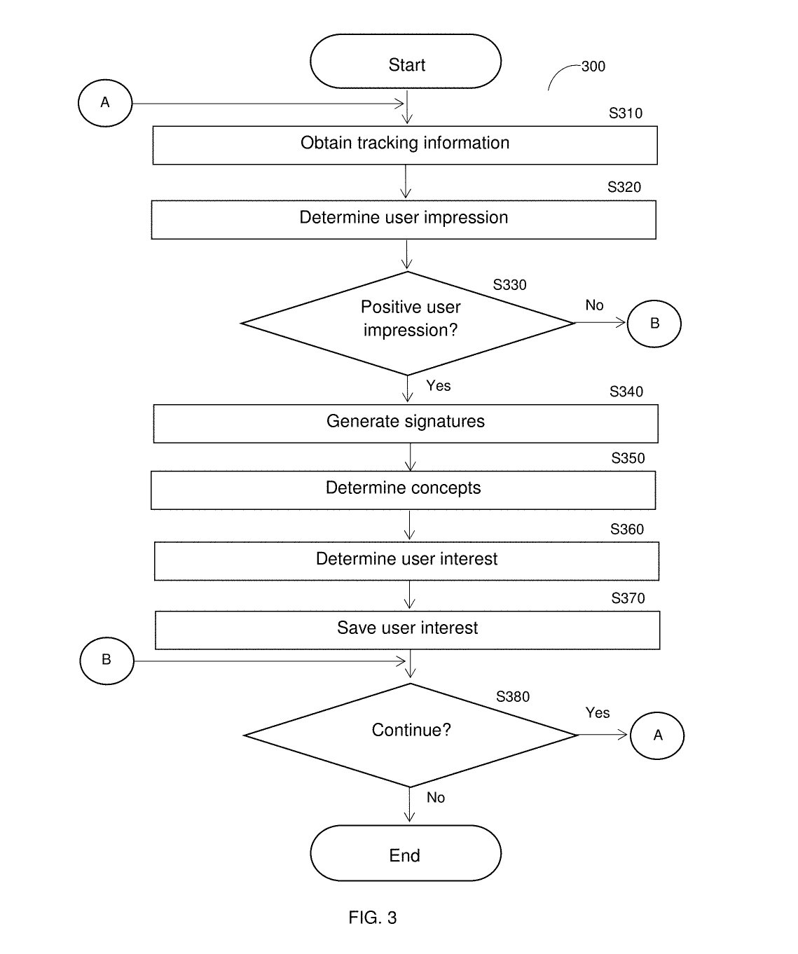

FIG. 3 depicts an example flowchart 300 illustrating a method for creating user profiles according to an embodiment. It should be noted that, in an embodiment, tracking information is collected by a user device. In various embodiments, tracking information may be collected from other sources such as, e.g., a database. In an embodiment, the method may be performed by a server (e.g., the interest analyzer 130).

At S310, tracking information of a user device is obtained (e.g., the user device 120-1). In an embodiment, the obtained tracking information may be received from, e.g., an agent installed on the user device and configured to collect tracking information. In a further embodiment, S310 may include filtering the tracking information. As noted above, the tracking information is collected with respect to a multimedia content element displayed over the user device. In an embodiment, the tracking information may include, but is not limited to, the multimedia content element (or a link thereto) displayed on the user device and user gestures with respect to displayed multimedia content element. In an embodiment, the tracking information may be collected via a web browser executed by the user device.

At S320, one or more user impressions is determined based on the obtained tracking information. Each user impression may be assigned a score based on a value of the user gestures utilized to determine the user impression. The score may further be positive or negative. In an embodiment, S320 may include filtering the user impressions so as to only determine meaningful impressions. The filtering may include, for example, filtering out any user impressions associated with a score that is below a predefined threshold.

The user impressions may be determined based on user gestures such as, but not limited to, a click on an element, a scroll, hovering over an element with a mouse, a change in volume, one or more key strokes, a combination thereof, and so on. The user impressions may further be determined to be either positive (i.e., demonstrating that a user is interested in the impressed element) or negative (i.e., demonstrating that a user is not particularly interested in the impressed element). One embodiment for determining the user impression is described herein above. The user impression is determined for one or more multimedia content elements identified in the tracking information.

At S330, it is checked if any of the user impressions are positive and, if so, execution continues with S340; otherwise, execution continues with S380. Whether a user impression is positive is discussed further herein above with respect to FIG. 1.

At S340, signatures are generated for each multimedia content element that is associated with a positive user impression. As noted above, the tracking information may include the actual multimedia content element or a link thereto. In the latter case, the multimedia content element is first retrieved from its location. The signatures for the multimedia content element may be generated by a signature generator system (e.g., the SGS 140) as described further herein below.

At S350, one or more concepts related to the multimedia content elements associated with positive user impressions is determined. In an embodiment, S350 includes querying a concept-based database using the generated signatures. In a further embodiment, S350 may include matching the generated signatures to at least one signature associated with concepts in the concept-based database. In yet a further embodiment, each of the concepts may be associated with one or more particular portions of the multimedia content element. As an example, a multimedia content element image of a man wearing a baseball shirt may be associated with the concept “baseball fan,” and the portions of the image related to the man may be associated with the concept “man” and the portions of the image related to the shirt may be associated with the concept “sports clothing” or “baseball.”

At S360, based on the determined concepts, the user interest is determined. Determining the user interest may include, but is not limited to, identifying a positive user impression with respect to any of the concepts. In an embodiment, the user interest may be further determined with respect to particular portions of the multimedia content element and user gestures related to those particular portions. For example, if a multimedia content element is an image showing a dog and a cat, a click on a portion of the image showing the dog may indicate a positive impression (and, therefore, a user interest), in “dogs” but not necessarily a user interest in “cats.”

As a non-limiting example of determining user interest, the user views a web-page that contains an image of a car. The image is then analyzed and a signature is generated respective thereto. As it appears that the user spent time above a certain threshold viewing the image of the car, the user's impression is determined as positive. It is therefore determined that a user interest is “cars.”

At S370, the determined user interest is saved as part of a user profile for the user in a database (e.g., the database 160). It should be noted that if no user profile for the user exists in the database, a user profile may be created for the user. A unique user profile may be created for each user of a user device. The user may be identified by a unique identification number assigned, for example, by the tracking agent. The unique identification number typically does not reveal the user's identity. Each user profile can be updated over time as additional tracking information is gathered and analyzed by the server. In an embodiment, the interest analyzer 130 analyzes the tracking information only when a sufficient amount of additional tracking information has been collected.

At S380, it is determined whether additional tracking information is received and, if so, execution continues with S310; otherwise, execution terminates. As noted above, in an embodiment, S380 may include determining whether a sufficient amount of additional tracking information has been received.

As a non-limiting example, tracking information including a video featuring a cat playing with a toy and a cursor hovering over the cat for 20 seconds is obtained from an agent installed on a user device. Based on the tracking information and, specifically, the cursor hovering over the cat for more than 5 seconds, it is determined that a user impression of the video is positive. A signature is generated for the video, and a concept of “cats” is determined. Based on the positive user impression of the concept of “cats,” a user interest in “cats” is determined. The user interest is saved as part of a user profile of the user.

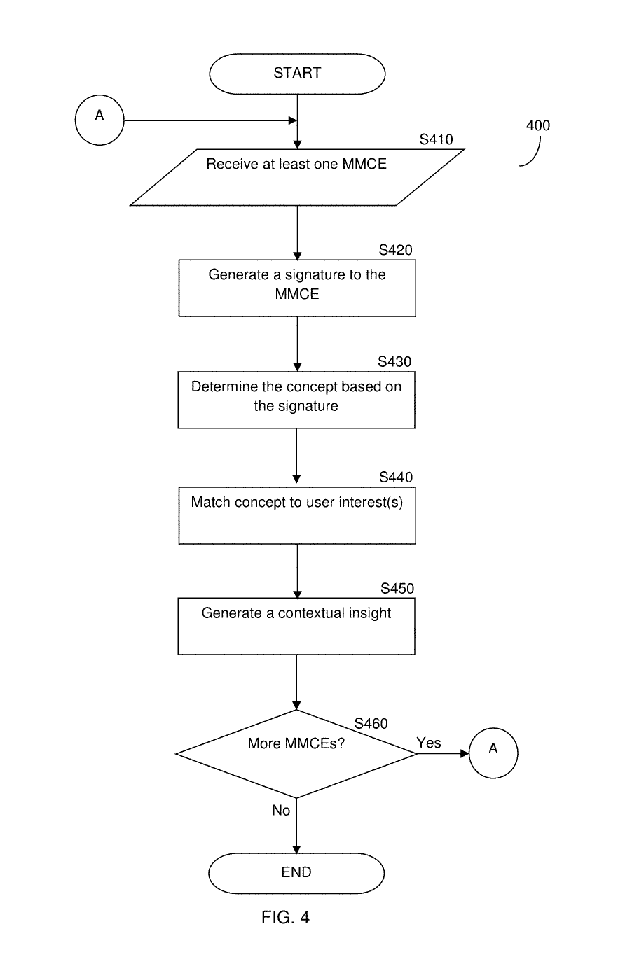

FIG. 4 depicts an example flowchart 400 illustrating a method for generating contextual insights according to another embodiment.

At S410, at least one multimedia content element is received. The multimedia content elements may be, for example, an image, a graphic, a video stream, a video clip, an audio stream, an audio clip, a video frame, a photograph, an image of signals (e.g., spectrograms, phasograms, scalograms, etc.), combinations thereof, or portions thereof. The at least one multimedia content element may be captured by a sensor included in a user device (e.g., the user device 120).

At S420, at least one signature is generated for each received multimedia content element. The signatures for the multimedia content elements are typically generated by a SGS (e.g., the SGS 140) as described hereinabove.

At optional S430, at least one concept is determined for each generated signature. In an embodiment, S430 includes querying a concept-based database using the generated signatures. In a further embodiment, the generated signatures are matched to signatures representing concepts stored in the concept-based database, and concepts associated with matching the generated signatures above a predetermined threshold may be determined.

At S440, the determined concepts are matched to user interests associated with the user. The user interests may be extracted from a user profile stored in a database (e.g., the database 160). In an embodiment, matching the concepts to the user interests may include matching signatures representing the determined concepts to signatures representing the user interests.

At S450, at least one contextual insight is generated based on a match between the user interest and the concept(s) or signature(s). The contextual insights are conclusions related to a preference of the user. For example, if a user interest is “motorcycles” and a concept related to multimedia content elements viewed by the user is “red vehicles,” a contextual insight may be a user preference for “red motorcycles.” As another example, if a user interest is “shopping” and a concept related to multimedia content elements viewed by the user is “located in Las Vegas, Nev.,” a contextual insight may be a preference for shopping outlets in Las Vegas, Nev.

At S460, it is checked whether additional multimedia content elements are received and, if so, execution continues with S410; otherwise, execution terminates.

FIGS. 5 and 6 illustrate the generation of signatures for the multimedia content elements by the SGS 140 according to one embodiment. An exemplary high-level description of the process for large scale matching is depicted in FIG. 5. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 6. Finally, Target Robust Signatures and/or Signatures are effectively matched, by a matching algorithm 9, to Master Robust Signatures and/or Signatures database to find all matches between the two databases.

To demonstrate an example of signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames.

The Signatures' generation process is now described with reference to FIG. 6. The first step in the process of signatures generation from a given speech-segment is to break down the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the interest analyzer 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3, a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={nᵢ} (1≦i≦L) may consist of a single leaky integrate-to-threshold unit (LTU) node or more nodes. The node nᵢ equations are:

$${V}_{i} = {\sum }_{j}^{ } {w}_{ij} {k}_{j}$$

$${n}_{i} = θ ( Vi - Thx )$$

where, θ is a Heaviside step function; wᵢⱼ is a coupling node unit (CNU) between node i and image component j (for example, grayscale value of a certain pixel j); kⱼ is an image component ‘j’ (for example, grayscale value of a certain pixel j); Thₓ is a constant Threshold value, where x is ‘S’ for Signature and ‘RS’ for Robust Signature; and Vᵢ is a Coupling Node Value.

The Threshold values Th_{X} are set differently for Signature generation and for Robust Signature generation. For example, for a certain distribution of values (for the set of nodes), the thresholds for Signature (Th_{S}) and Robust Signature (Th_{RS}) are set apart, after optimization, according to at least one or more of the following criteria:

For: Vᵢ>Th_{RS}

1−p(V>Th_{S})−1−(1−ε)^{l}<<1 1:

i.e., given that l nodes (cores) constitute a Robust Signature of a certain image l, the probability that not all of these l nodes will belong to the Signature of a same, but noisy image, Ĩ is sufficiently low (according to a system's specified accuracy).

p(Vᵢ>Th_{RS})≈l/L

i.e., approximately l out of the total L nodes can be found to generate a Robust Signature according to the above definition.
3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. Nos. 8,326,775 and 8,312,031, assigned to the common assignee, which are hereby incorporated by reference.

A Computational Core generation is a process of definition, selection, and tuning of the parameters of the cores for a certain realization in a specific system and application. The process is based on several design considerations, such as:
(a) The Cores should be designed so as to obtain maximal independence, i.e., the projection from a signal space should generate a maximal pair-wise distance between any two cores' projections into a high-dimensional space.
(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.
(c) The Cores should be optimally designed with regard to invariance to a set of signal distortions, of interest in relevant applications.

A detailed description of the Computational Core generation and the process for configuring such cores is discussed in more detail in the above-noted U.S. Pat. No. 8,655,801, the contents of which are hereby incorporated by reference.

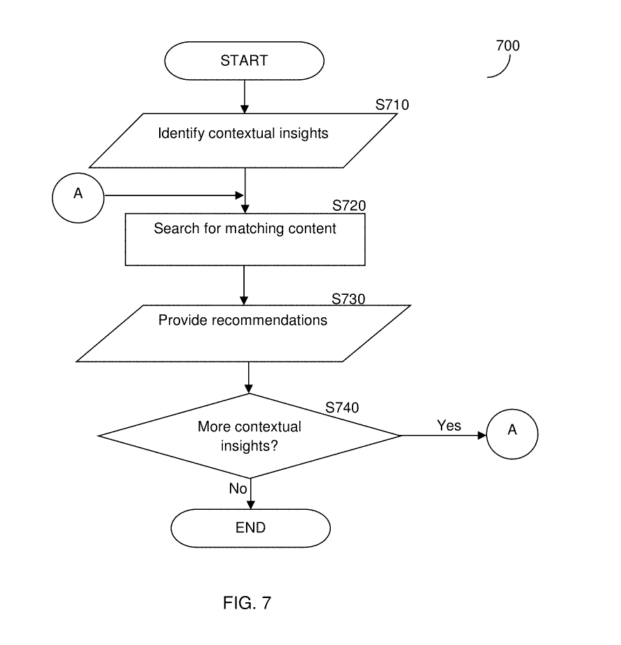

FIG. 7 depicts an example flowchart 700 illustrating a method for providing recommendations to users based on contextual insights according to an embodiment. It should be noted that, in various embodiments, recommendations may be provided without first receiving multimedia content elements to analyze. In such embodiments, recommendations may be determined and provided in response to, e.g., a predetermined event, input from a user, and so on. As a non-limiting example, a user may request a recommendation for a movie or TV show to watch on a video streaming content website based on his or her interests.

At S710, at least one contextual insight indicating a preference of the user is identified. In an embodiment, the at least one contextual insight may be identified based on, but not limited to, a request for a recommendation, a user profile of the user, a multimedia content element provided by the user (via, e.g., a user device), a combination thereof, and the like. In another embodiment, the at least one contextual insight may be generated as described further herein above with respect to FIG. 4.

At S720, a search for content items matching the identified contextual insights is performed. The matching content items may include, but are not limited to, multimedia content elements, web-pages featuring matching content, electronic documents featuring matching content, combinations thereof, and the like. In an embodiment, S720 may include matching signatures representing the identified contextual insights to signatures of content items of one or more web sources. As an example, if a contextual insight is a preference for “police dramas,” content items related to television and movie dramas prominently featuring police and detectives may be found during the search.

At S730, upon identification of at least one matching content item, the at least one matching content item is provided as a recommendation to the user device. Providing the matching content items as recommendations may include, but is not limited to, providing one or more links to each content item, providing identifying information about each content item, sending the content items to the user device, notifying the user of content items existing on the user device, combinations thereof, and so on. To this end, S730 may include sending the recommended content items to the user device.

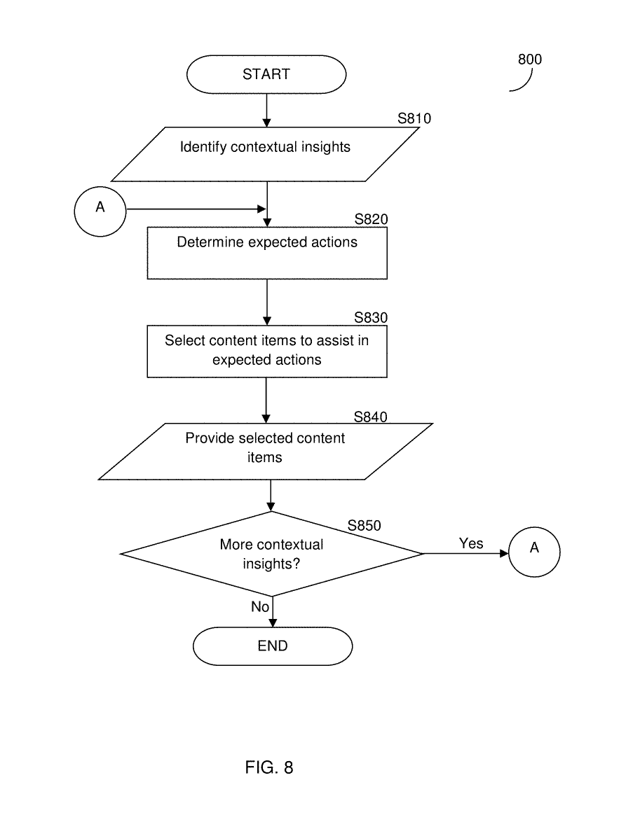

In an embodiment, providing the content items as a recommendation may further include causing execution or display of the recommended content items. To this end, the recommended content items to be executed or displayed may be selected from among the matching content items based on expected actions determined for the user. An example flowchart illustrating providing content items based on expected actions is described further herein below with respect to FIG. 8.

At S740, it is checked whether additional contextual insights are identified and, if so, execution continues with S720; otherwise, execution terminates.

As a non-limiting example, in case the user is determined as currently viewing an image of a vehicle such as a Ford® Focus, and a user profile indicates that he is based in Manhattan, N.Y., a link to a financing institution that offers financing plans for purchasing vehicles may be found and provided as a recommendation to the user device.

FIG. 8 depicts an example flowchart 800 illustrating a method for providing content items based on expected actions of a user of a user device according to an embodiment. It should be noted that, in various embodiments, the content items may be provided without first receiving multimedia content elements to analyze. In such embodiments, the content items may be selected and provided in response to, e.g., a predetermined event, inputs from a user, and so on.

At S810, at least one contextual insight indicating an action expected to be performed by the user is identified. In an embodiment, the at least one contextual insight may be identified based on, but not limited to, a request for an action, a user profile of the user, a multimedia content element provided by the user (via, e.g., a user device), a combination thereof, and the like. In another embodiment, the at least one contextual insight may be generated as described further herein above with respect to FIG. 4.

At S820, one or more expected actions that the user is likely to perform via the user device 120 are determined based on the identified contextual insights. The determination may be made based on previous data, similar cases, contextual analysis of one or more actions made by the user of the user device, and the like. As an example, if the contextual insights indicate a current interest in “ride sharing NYC” and the user has previously used a ride sharing service, it may be determined that the user is likely to download and open a ride sharing application.

At S830, one or more content items to be utilized to assist the user in performing the expected actions are selected from among content found based on contextual insights. To this end, S830 may include searching based on the contextual insights as described herein above with respect to FIG. 7. The searching may be in one or more web sources, one or more databases, in the user device, or a combination thereof. For example, an application to be executed may be found in the user device, or may be found in an application repository and downloaded to the user device. The content items may include, but are not limited to, multimedia content elements, web-pages featuring matching content, electronic documents featuring matching content, communication requests, content requests, combinations thereof, and the like. In an embodiment, S830 may include matching signatures representing the identified contextual insights to signatures of content items.

The content items to be utilized are selected from among the found content items based on the expected actions. As non-limiting examples, contextually appropriate applications may be selected when the expected actions include opening an application on the user device, contextually appropriate videos may be selected when expected actions include viewing videos, contextually appropriate web pages may be selected when expected actions include opening a web browser, a messaging application stored in the user device may be selected when the expected actions include a communication request, and the like.

At S840, upon identification of at least one matching content item, the matching content items are provided to the user device 120. Providing the matching content items may include, but is not limited to, providing one or more links to each content item, providing identifying information about each content item, sending the content items to the user device 120, notifying the user of content items existing on the user device, causing launching of a link or a program associated with the content item, combinations thereof, and so on.

At S850, it is checked whether additional contextual insights are identified and, if so, execution continues with S820; otherwise, execution terminates.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

What is claimed is:

1. A method for providing a content item based on a user interest and an expected action to be performed by a user device, comprising:
querying, based on at least one signature generated for a multimedia content element, a user profile to identify the user interest, wherein a concept of the identified user interest matches a concept represented by the generated at least one signature;
generating at least one contextual insight based on the user interest, wherein each contextual insight indicates a user preference;
determining the expected action based on the at least one contextual insight;
determining, based on the expected action, the content item to be provided to the user device; and
providing the determined content item to the user device.

2. The method of claim 1, further comprising:
determining, based on the at least one signature generated for the multimedia content element, the concept of the multimedia content element, wherein the at least one contextual insight is generated based further on the concept of the multimedia content element.

3. The method of claim 2, wherein the user profile is queried based on the determined concept, wherein the user interest is determined further by mapping the determined concept to the user interest using an association table.

4. The method of claim 2, wherein the concept is determined by querying a concept-based database using the at least one signature.

5. The method of claim 1, wherein determining the content item to be provided to the user device further comprises:
generating at least one contextual insight signature for the at least one contextual insight; and
matching the at least one contextual insight signature to content item signatures associated with a plurality of content items to identify at least one matching content item; and
selecting the content item to be provided from among the at least one matching content item based on the at least one expected action.

6. The method of claim 1, wherein the generated at least one signature is robust to noise and distortions.

7. The method of claim 1, wherein the content item is a multimedia content element, wherein providing the content item to the user device includes causing a display of the multimedia content item on the user device.

8. The method of claim 1, wherein the content item is an application, wherein providing the content item to the user device includes causing a launch of the application on the user device.

9. The method of claim 1, wherein the concept is a collection of signatures representing at least one conceptually related multimedia content element and metadata describing the concept, wherein the collection of signatures is a signature reduced cluster generated by inter-matching signatures generated for the at least one multimedia content element.

10. The method of claim 1, wherein each signature is generated by a signature generator system, wherein the signature generator system includes a plurality of computational cores configured to receive a plurality of unstructured data elements, each computational core of the plurality of computational cores having properties that are at least partly statistically independent of other of the computational cores, wherein the properties of each core are set independently of each other core.

11. A non-transitory computer readable medium having stored thereon instructions for causing a processing system to perform a process for providing a content item based on a user interest and an expected action to be performed by a user device, the process comprising:
querying, based on at least one signature generated for a multimedia content element, a user profile to identify the user interest, wherein a concept of the identified user interest matches a concept represented by the generated at least one signature;
generating at least one contextual insight based on the user interest, wherein each contextual insight indicates a user preference;
determining the expected action based on the at least one contextual insight;
determining, based on the expected action, the content item to be provided to the user device; and
providing the determined content item to the user device.

12. A system for providing a content item based on a user interest and an expected action to be performed by a user device, comprising:
a processing circuitry; and
a memory, wherein the memory contains instructions that, when executed by the processing circuitry, configure the system to:
query, based on at least one signature generated for a multimedia content element, a user profile to identify the user interest, wherein a concept of the identified user interest matches a concept represented by the generated at least one signature;
generate at least one contextual insight based on the user interest, wherein each contextual insight indicates a user preference;
determine the expected action based on the at least one contextual insight;
determine, based on the expected action, the content item to be provided to the user device; and
provide the determined content item to the user device.

13. The system of claim 12, wherein the system is further configured to:
determine, based on the at least one signature generated for the multimedia content element, the concept of the multimedia content element, wherein the at least one contextual insight is generated based further on the concept of the multimedia content element.

14. The system of claim 13, wherein the user profile is queried based on the determined concept, wherein the user interest is determined further by mapping the determined concept to the user interest using an association table.

15. The system of claim 13, wherein the concept is determined by querying a concept-based database using the at least one signature.

16. The system of claim 12, wherein the system is further configured to:
generate at least one contextual insight signature for the at least one contextual insight; and
match the at least one contextual insight signature to content item signatures associated with a plurality of content items to identify at least one matching content item; and
select the content item to be provided from among the at least one matching content item based on the at least one expected action.

17. The system of claim 12, wherein the generated at least one signature is robust to noise and distortions.

18. The system of claim 12, wherein the content item is a multimedia content element, wherein providing the content item to the user device includes causing a display of the multimedia content item on the user device.

19. The system of claim 12, wherein the content item is an application, wherein providing the content item to the user device includes causing a launch of the application on the user device.

20. The system of claim 12, wherein the concept is a collection of signatures representing at least one conceptually related multimedia content element and metadata describing the concept, wherein the collection of signatures is a signature reduced cluster generated by inter-matching signatures generated for the at least one multimedia content element.

21. The system of claim 12, wherein each signature is generated by a signature generator system, wherein the signature generator system includes a plurality of computational cores configured to receive a plurality of unstructured data elements, each computational core of the plurality of computational cores having properties that are at least partly statistically independent of other of the computational cores, wherein the properties of each core are set independently of each other core.
